(19) United States
(12) Patent Application Publication
(10) Pub. No.: US 2014/0111795 A1
(43) Pub. Date: Apr. 24, 2014

(54) SYSTEMS AND METHODS OF PERFORMING REFLECTION AND LOSS ANALYSIS OF OPTICAL-TIME-DOMAIN-REFLECTOMETRY (OTDR) DATA ACQUIRED FOR MONITORING THE STATUS OF PASSIVE OPTICAL NETWORKS

(71) Applicant: NTest, Inc., Minneapolis, MN (US)

(72) Inventors: Andrew Barnhart, Gaithersburg, MD (US); Robert Gwynn, Bloomington, MN (US)

(73) Assignee: NTest, Inc., Minneapolis, MN (US)

(21) Appl. No.: 14/057,580

(22) Filed: Oct. 18, 2013

Related U.S. Application Data
(60) Provisional application No. 61/715,661, filed on Oct. 18, 2012.

(51) Int. Cl. G01M 11/00

(52) U.S. Cl. CPC G01M 11/3145
USPC 356/73.1

(57) ABSTRACT

To allow for the characterization of a passive optical network, reflectometry data is closely analyzed to determine reflection events within the data, and to subsequently characterize the reflection events so the status, operating parameters and efficiency of the network can be monitored. The reflectometry data is analyzed using statistical techniques to identify and analyze reflection events, which will ultimately allow meaningful reports to be generated which characterize the operation of the passive optical network. The reports can thus be provided to operators and/or installers to determine the health of the network, and whether any revisions are necessary.

### LISTING OF RELATED APPLICATIONS

This application claims the benefit of previously filed U.S. provisional application 61/715,661, filed Oct. 18, 2012.

### BACKGROUND

The present invention is generally directed to a system and method used in performing reflection and loss analysis of optical-time-domain-reflectometry (OTDR) data acquired for the purpose of monitoring the status of passive optical networks. More specifically, the system and method performs analysis of passive optical networks, and alerts operators and/or installer of any issues or problems.

### BRIEF DESCRIPTION OF THE DRAWINGS

Further details of the system will be understood by referring to the following descriptions in conjunction with the figures, in which:

FIGS. 1 & 2 make up a block diagram illustrating the steps carried out to perform reflection analysis of a passive optical network;

FIGS. 3-4 make up a block diagram showing the steps carried out to perform the loss event detection of a passive optical network;

FIGS. 5-6 show the steps carried out to analyze the loss events discovered, and to report the results of the overall analysis; and

FIG. 7 is a schematic diagram of a system utilized to carry out certain embodiments of the reflection analysis, event detection, and loss analysis of a passive optical network.

### DETAILED DESCRIPTION

Outlined below are several steps carried out by an example embodiment which is capable of characterizing passive optical networks, for purposes of validating and/or troubleshooting. As will be recognized by those skilled in the art, the various tools of the described embodiments can be utilized by those attempting to validate new optical networks, and those troubleshooting problems/issues with existing optical networks. Generally speaking, the example methods and systems outlined below identify and analyze reflection events, loss events and/or both. The ability to perform this analysis will provide the ability to validate new optical networks, or troubleshoot existing optical networks, depending upon the circumstance. Additionally, the various tools utilized to analyze and characterize reflection event, losses, or both will be beneficial depending upon the various circumstances involved. Based upon the desired results, various pieces of information can be provided to installers or administrators as necessary.

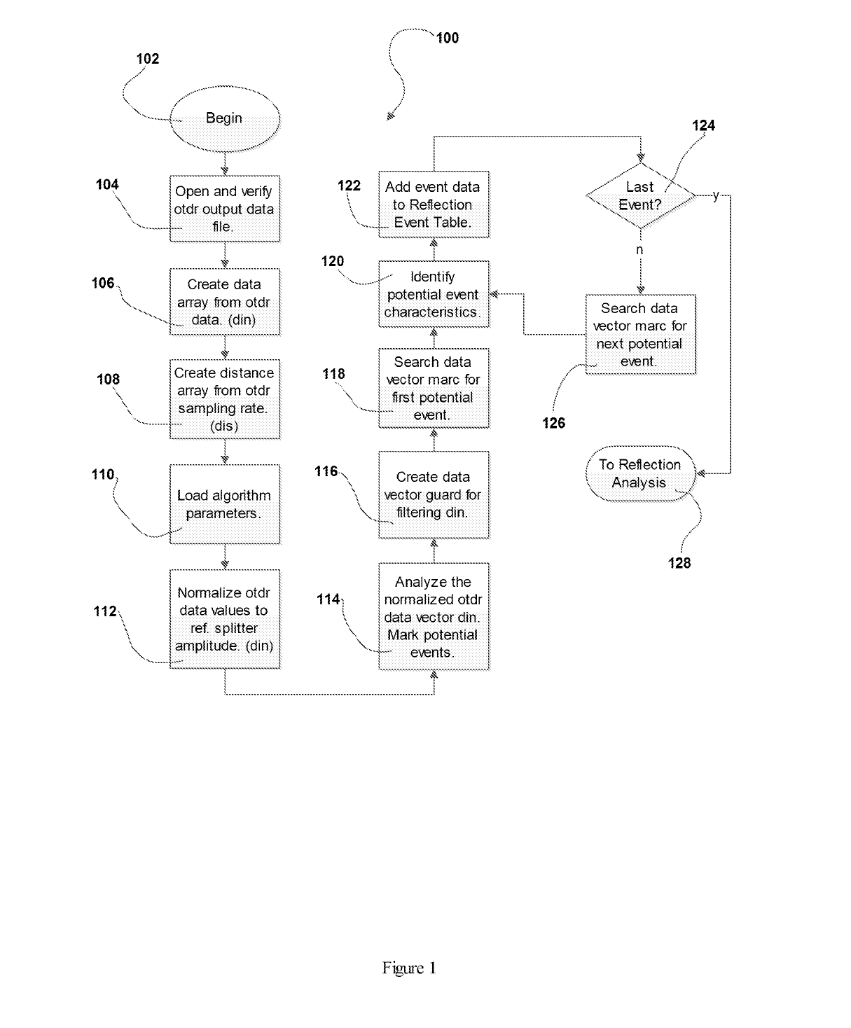

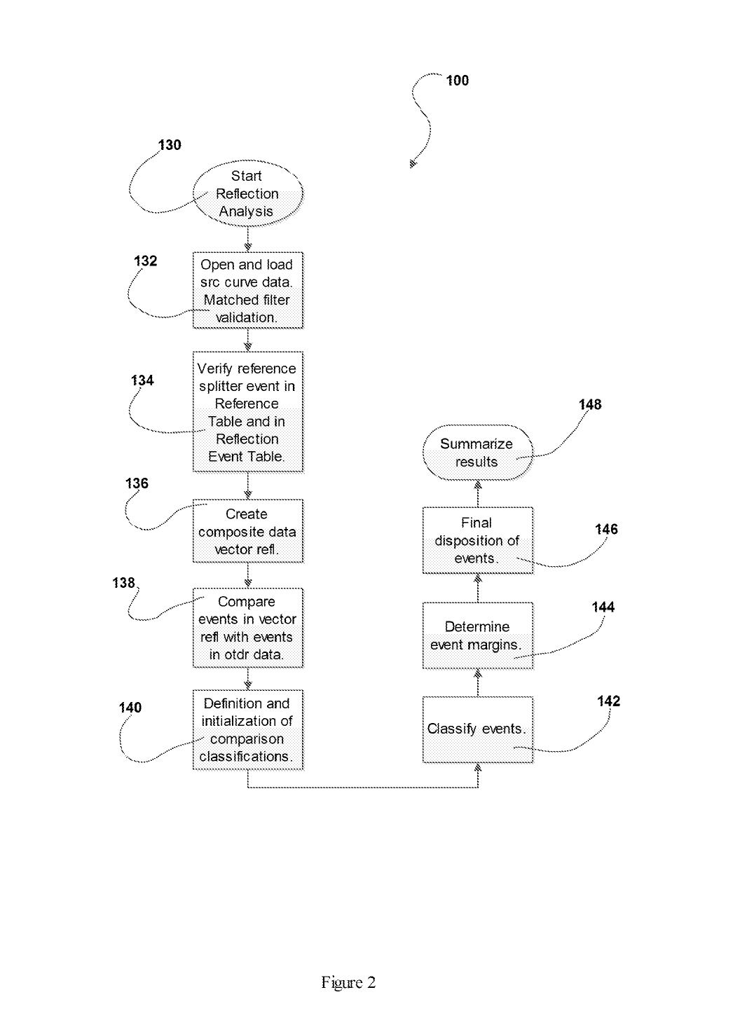

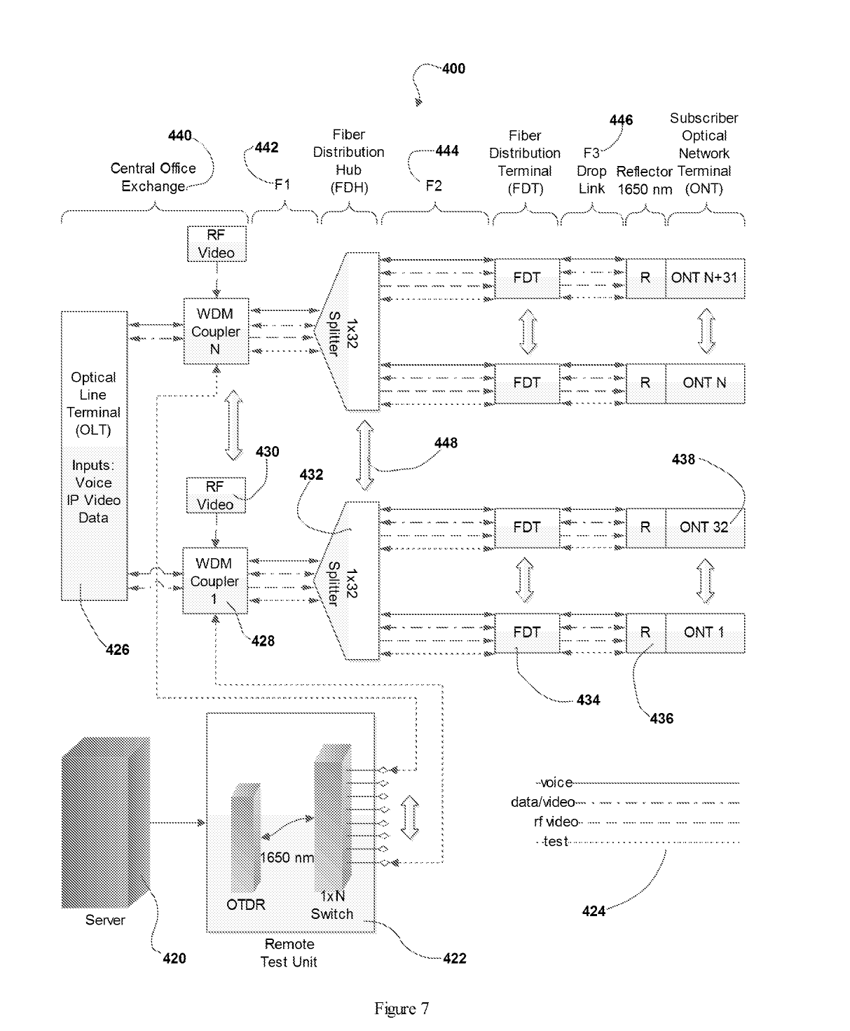

The overall reflection analysis 100 carried out by the disclosed system and method is composed of many sub-modules, several of which have been combined into more general blocks or steps as shown in FIGS. 1 & 2. The first eleven blocks or steps are shown in FIG. 1, while the remaining blocks or steps are shown in FIG. 2. An example of the system used to accommodate reflection analysis 100 is further discussed below in reference to FIG. 7 As shown in each of the Figures, references to each block or step is made using reference numbers, wherein like number refer to like steps or components.

The disclosed reflection analysis 100, illustrated in FIGS. 1 & 2 begins at an initial step 104, where optical-time-domain-reflectometry (OTDR) output data file is opened and verified. Once verified, the OTDR output data is used to create a filtered data array (din) which can then be used for further evaluation and analysis. Similarly, a distance array (dis) is created in step 108, based upon the OTDR sampling rate utilized. The reflection analysis 100 then moves to step 110, where several parameters are loaded from a local .ini file, In this embodiment, these parameters include:
a. nave: number of averages for statistical calculations
b. psigma: positive forward sigma that sets upper statistical limit
c. nsigma: negative forward sigma that sets lower statistical limit
d. rthres: threshold power ratio for reflections
e. guardUp: filter parameter for positive noise suppression in between events
f. guardDn: filter parameter for negative noise suppression in between events
g. nMark: filter parameter for event detection
h. thMiss: event classification threshold
i. thGrey: event classification threshold
j. thHigh: event classification threshold
k. srcCurve: standard reflection characterization

Next, in step 112, the OTDR data vector (din) is normalized based upon a reference splitter peak amplitude. This normalization is an amplitude scaling of the OTDR data converted to a value representative of power.

The scaled, normalized OTDR data vector (din) is then analyzed to identify certain characteristics or events in step 114. This analysis consists of examining each of the data points in sequence and creating a marking array (marc). The values of this data vector (marc) are determined as follows: For each increasing value in the data vector (din), insert a ‘1’ in the marking vector (marc) at the same index. For decreasing values, insert a ‘0’ in the marking vector (marc). This creates a marking vector (marc) consisting of a series of ‘1’s and ‘0’s where consecutive sequences of ‘1’s indicate consecutively increasing values of power as recorded in the scaled OTDR data vector (din). Next, the marking vector (marc) is inspected for sequences of ‘1’s consisting of at least ‘nMark’ ‘1’s. The variable ‘nMark’ is programmable and is part of the parameters loaded early in the analysis process. In a sequence, for any ‘1’ vector value equal and above ‘nMark’ in number, the vector value is changed to ‘3.’ Finally, any consecutive sequence of ‘1’s and ‘3’s is changed to a string of ‘2’s and ‘3’s by changing the ‘1’ data values to ‘2’ within any validated sequence. These new sequences of ‘2’s and ‘3’s mark or index the location of potential reflection events in the OTDR data.

At the next step, step 116, a new data vector is created which reflects a baseline for the OTDR data. This new data vector (guard) is computed using the marking vector (marc) to gate or control the overall computation. When the marking vector (marc) indicates a potential event, the present evaluation process holds onto the last pre-event calculated value. When the marking vector (marc) indicates a non-qualifying potential event, a new value for this new vector (guard) is calculated based on programmable limits used in an estimation for statistical variability.

Next, in step 118, the system and process will search for the first potential event. This section begins by opening the marking data vector (marc) and examining the data. A search is done for the first ‘3’ value. When the first ‘3’ is found, the search is continued to find the last ‘3’ in the same sequence. This identifies the index of the “peak” value in the current potential event sequence.

Continuing with the analysis of the marking data vector (marc) in step 120, the index of the last ‘3’ in the current sequence is identified as the peak-of-event (poe) parameter. The value at the same index in the data vector (din) is identified as the event amplitude. A search is then made backwards in the current sequence until a ‘0’ value is found. This identifies the beginning-of-event (boe) parameter. The process is then focused again on the poe index and a search is continued forward until a ‘0’ value is found. This identifies the end-of-event (eoe) parameter.

A Reflection Event Table is next opened and initialized in step 122. This table is then populated with the event characteristics identified in step 120. Additional information regarding each event is also recorded in the table. This additional information includes boe, poe and eoe (typically recorded in meters) in addition to status and type for each event. This is carried out using decision step 124 to analyze if this is the last event.

Focus is shifted back to the marking data vector (marc) at the index of the last peak-of-event (poe) found. Step 126 directs the appropriate search, to continue this process, starting again at step 120. A forward search from this index is then done for the first ‘3’ value. This starts the same cycle as shown in steps 120 and 122, until the last or final potential event is identified. At that point, the reflection analysis continues, as shown in connector 128.

The next nine blocks or steps are shown in FIG. 2. As shown and discussed below, additional information is utilized to continue the reflection analysis generally introduced above.

This section of the reflection analysis 100 opens and processes a standard-reflection-curve (src) at step 132, which is an array or vector of numbers which designate a series of normalized amplitudes sampled at a regular interval. The assumed sample rate is equal to the maximum sample rate to be used by the OTDR when collecting a trace. When plotted against a sequential sample number, the series of normalized amplitudes trace a curve which defines a characteristic reflection response to an optical pulse interacting with a typical discontinuity encountered in a fiber-ONT termination as measured by the OTDR system monitoring the network. The characteristic response curve contains system response information related to that encountered when measuring a system impulse response. This characteristic response curve can also be considered a template or model for use in matched filtering. A matched filter can now be used to validate the reflection events in the Reflection Event Table.

The process then moves to step 134, wherein the data vector (din) is opened and the reference splitter event is identified. The reference splitter event is then analyzed and the peak of the event is determined. The reference splitter peak amplitude is then updated in the Reflection Event Table. Next, the ratio between the reference splitter peak amplitude recorded in the Reflection Event Table, and that recorded in the Reference Table is calculated. This ratio is then used to normalize the data vector (din) as well as the event amplitudes in the Reflection Event Table. The ratio is also saved.

Another composite array or data vector (refl) is created in step 136, which has scaled and interpolated standard-reflection-curve (src) values indexed according to OTDR sample numbers for each of the events listed in the Reference Table. The scaling is derived from the data vector (din) event peaks. The amplitude values are determined for the modified src curve by interpolating between the src samples. The interpolated amplitude values are calculated at the OTDR data sample distances. The OTDR data vector (din) peaks are aligned with the src peak at the peak value and each event beginning (boe) is assumed to be nMark samples before the peak value. Each event (of N events) end-of-event (eoe) is assumed to be boe+(peakN_src_samples-1)×(src_intvl). This results in a list of “template” events, each corresponding to a Reference Table event.

In step 138 the Reference Table is opened and the first “ONT” type event is examined. The event beginning (boe) parameter is loaded and corresponding values for peak and end are calculated using the standard reflection curve (src). The sample number is determined for the approximate event peak and this is used to retrieve a value for peak power from the composite vector (refl.) Next, the corresponding power value in the OTDR data vector (din) is retrieved and the ratio between the two is computed. This is done for all events in the Reference Table, and the peak ratios are stored. The event peak areas are then computed and their ratios are determined (between composite vector (refl) and data vector (din)) and stored. The metrics peak-ratio and peak-area are designated for each event listed in the Reference Table.

Next, at step 140 The peak-ratio proximities with regards to ‘1’ are determined. The largest proximity numbers are tracked. The area-ratio proximities with regards to ‘1’ are also determined. The largest area proximity numbers are tracked. The event ratio numbers are then prepared for classification. Three event thresholds are used: thMiss, thGrey and thHigh. These are programmable values which are part of the perameters loaded in step 110.

Each event ratio as identified by comparing the vector (refl) values with the vector (din) values is classified at step 142. In this embodiment, if ratio<thMiss, then the event is classified as a ‘Miss.’ Similarly, if thMiss<ratio<thGrey, then the event is classified as a ‘Grey.’ Lastly, if thGrey<ratio<thHigh, then the event is classified as ‘OK.’ If ratio>thHigh, then the event classified as a ‘High’.

As the process continues, event margins are then determined in step 144. If ratio<thMiss, then the margin related to ‘Miss’ threshold is calculated. This metric reflects how close a ratio is to the threshold as a percentage. If ratio<thGrey, then the margins to both ‘Miss’ and ‘Grey’ thresholds are calculated. If ratio<thHigh, then the margins to both ‘Grey’ and ‘High’ thresholds are calculated.

As a final part of the reflection analysis 100, all events classifications are refined based on the margin calculations at step 146. The final classifications are determined as ‘Miss,’ ‘Grey,’ ‘OK-low,’ ‘OK-high’ and ‘High.’ The events in the ‘Grey’ category are processed further. The process then looks for clusters of ‘Grey’ events and attempts to optimize the thresholds, thGrey and thMiss, to validate the decision between ‘Grey’ and ‘Miss’ classifications. The final classifications are updated as necessary.

To provide useful information to operators, or other individuals evaluating the optical network, reflection results are summarized and published in step 148. The published results include:
a. Number of ONTs with no faults: number of (‘OK-low’+‘OK-high’) events
b. Missing ONTs: number of ‘Miss’ events
c. ONTs with high reflection: number of ‘High’ events
d. ONTs with minor loss: number of ‘Grey’ events

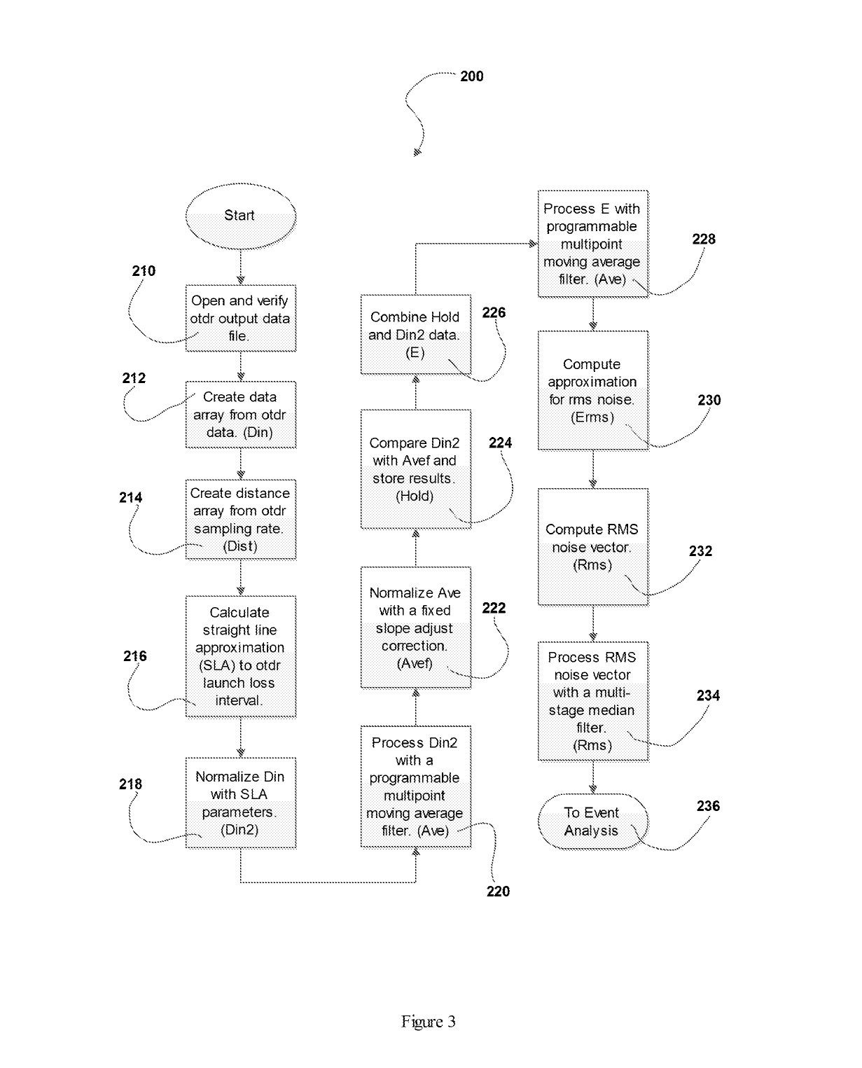

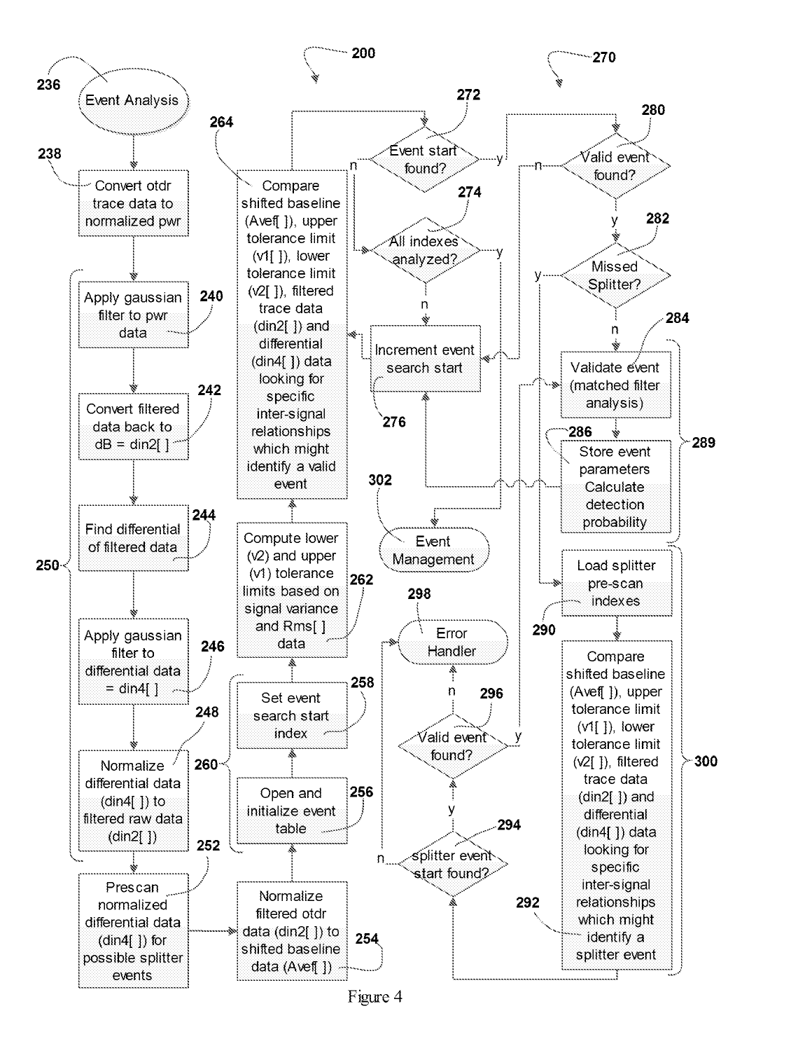

The next aspect of the present embodiments includes a loss analysis section 200 composed of many steps which are combined into more general blocks as illustrated in FIGS. 3 and 4. The first thirteen steps or blocks are shown in FIG. 3. This begins by first opening and verifying the OTDR Data file in step 210, and subsequently creating a related data array (Din) in step 212. Similarly, an array (Dist) is created using the OTDR sampling rate, in step 214. These steps are similar to those carried out in the above discussed reflection analysis 100, and would make use of those previously conducted processes.

Using the above referenced information, linear curve fitting is used in step 216 to determine the y-intercept of the launch backscatter.

In step 218, the y-intercept determined at step 216, is used to normalize the raw OTDR (Din) data resulting in normalized vector (Din2).

The normalized OTDR data vector (Din2), is then processed with a balanced variable width smoothing or averaging (low-pass) filter to produce an averaged data vector (Ave). This filter is a sliding-window, mean basis filter. Basic statistics are also computed during this step.

At step 222, the averaged OTDR data vector (Ave) is processed further by applying a normalization correction to compensate for errors introduced by the smoothing filter. The vector is also time-shifted to prepare for analysis. This results in an averaged and normalized data vector (Avef).

Next, a new data set is computed which takes the averaged and normalized OTDR data (Avef) and adds to it an expected variability component. This new data set is then compared point by point with the raw OTDR data (Din) producing a hold data vector (Hold). The hold data vector, (Hold), indicates all areas of the raw OTDR data where the raw data exceeds the expected statistical variability. In these regions, the hold data vector (Hold) stores the averaged and normalized values (i.e. the hold vector stores clamped values).

At the following step, step 226 the hold vector data (Hold) is then combined with the normalized raw OTDR information (Din2) to produce a new data vector (E).

The new data vector, (E), is now filtered with a sliding-window mean basis filter at step 228, to rewrite the average data vector (Ave). This rewritten data set is then used to determine the end or limit of the passive optical network. This information is used later in calculating RMS noise. Dynamic range is also computed in this block by analyzing the raw OTDR data and building a histogram followed by a conversion to a probability mass function.

The rewritten data vector (Ave) is now normalized and time-shifted at step 230, producing a rewritten average data vector (Avef). This vector is now is analyzed for outliers and statistical limits are imposed, resulting in a new data vector which approximates the root-mean-squared noise amplitude. This new data vector is thus considered the rms data vector (Erms), which is appropriately stored for future use.

The data rms vector (Erms) is now filtered at step 232 resulting in a new rms vector (Rms). The filter used is another balanced sliding-window mean basis filter, similar to the filter discussed above.

Next, at step 234, the new rms data vector (Rms) is filtered again using a four-stage sliding-window median basis filter.

The next event detection blocks of loss analysis are shown in FIG. 4. This section of the loss analysis starts off by again operating on the raw OTDR data vector (Din). These multiple steps 250, can be characterized as further conditioning the data vector to provide calculated data vectors which are helpful in further operations. First, at step 238 the raw data vector is converted to normalized power. Next, the data vector is filtered with a Gaussian filter (step 240). Then at step 242, it is converted back to dB to form the normalized and filtered data vector (din2). The normalized and filtered data vector (din2) is further processed by finding the differential and filtering with a Gaussian filter, to form the differential data vector (din4). The vector (din4) is then normalized to the filtered data vector (din2) whch then creates a convenient baseline.

The differential data vector (din4) is then analyzed at step 252 to determine if any splitter events are possibly present. This is determined by comparing the characteristic shape of a splitter differential response to the (din4) vector. This characteristic shape is detected by slope calculations and curve fitting. An estimate of the start indices of the potential splitter events are saved for further analysis.

At step 254 the data vectors to be used in event detection are prepared further prior to analysis. The lightly filtered OTDR data, (din2) is carefully normalized to the heavily filtered baseline vector (Avef.) This is done by choosing a non-event section of both vectors and computing a linear model for each chosen section. The offset between the two models is then iteratively reduced by computing and minimizing a least-squares comparison between the two.

Next, a pair of general processing steps 260 are carried out. More specifically, an event table is opened and initialized. This table keeps track of all of the parameters used to detect, validate and quantify events. This block also initializes the event detection software loop at step 264 that examines the necessary vector data to detect potential events.

A lower limit variability data vector, (v2), is next created in step 262 by summing together the arranged and normalized data vector (Avef) and the new rms vector (−Rms) multiplied by a programmable constant, (nsigma). A upper limit variability data vector, (v1), is created by summing together the arranged and normalized vector (Avef) and the new rms vector (Rms) multiplied by a programmable constant, (psigma). These two new vectors are used during event detection to establish expected variability.

Moving to step 264, basic signal processing is done to look for and identify potentially valid events. This process uses five different vectors in order to perform this detection. The vectors used are (Avef), (v1), (v2), (din2) and (din4). Again, vector (Avef) represents a time-shifted version of the signal baseline with minimum variability. As previously described, vector (v1) and vector (v2) describe the expected statistical variation around the baseline. Vector (din2) is the lightly filtered raw OTDR signal. Vector (din4) is a computed and filtered differential of vector (din2). These five vectors are compared point by point and the patterns that emerge are used to detect potential events. Specifically, flags are created which track the positions of the curves relative to each other and metrics are created which track local inter-signal and intra-signal measurements. These flags track position details such as crossing points, crossing slopes, local maxima, local minima, positive and negative proximity etc. The metrics track measurements of crossing slopes, local slopes, local maxima, local minima, positive and negative proximity, positive and negative areas etc. Appropriate sequences of these flags (or lack thereof) along with their associated metrics are noted by marking the vector data. From the marking data, a probability metric is calculated, quantifying the potential event. The probability computed is a normalized value that relates the marked data values to the expected signal variability at specific times (indexes) in the time series.

With all of the above referenced information available, the reflection analysis 200 then begins a general decision loop 270. The general decision loop that is employed in this module is generally described as follows: (a) Has a potential event start been found 272? (b) If so, finish tracking, measuring and constructing the potential event. (c) If not, check to see if all the data has been analyzed 274 and if it has not, increment the event search start window 276 and look for a new event beginning 272. (d) After constructing the found potential event, qualify the event by checking probability 286. (e) Next, check the qualified event to see if it is an expected splitter. (f) If the qualified event is not a splitter, check to see if the the event occurs after the expected splitters as determined in the splitter prescan module 252. (g) If the event occurs after the expected splitters, check to see if the splitters_found flag is set. (h) If the splitters_found flag is set, fully validate the event 284. (i) Store the event in the events table, increment the search window and continue to look for the next event 286,276. (j) If the event occurs after the expected splitters but the splitters_found flag is not set, load the splitter prescan window indexes 290. (k) Analyze the vector data with the splitter detection module 292. (l) If the expected splitter is found, validate the splitter event 284. (m) Store the splitter event in the events table 286, increment the search window and continue to look for the next event 276. (n) If the expected splitter is not found, navigate to error handling module 298 and stop execution until the problem is fixed. (o) When all the vector data has been analyzed, navigate to the Event Management module 302.

To validate the event at portion 289, each sequence of validated marks that potentially identify an event, the individual constituent probabilities are summed to define a single probability metric which is then compared to a programmable threshold. If the event probability metric compares favorably with the required threshold, a flag is set (pflag) which validates the probability potential of the event. Next, a matched filter analysis is performed where a model for (din2) is calculated. This model can take the form of a full wavelet, partial wavelet (both scaled and normalized by a characteristic OTDR response) or a characteristic OTDR reflection response only. Next, a correlation procedure is performed between the model and (din2) to dramatically increase the event signal-to-noise ratio (SNR). This provides the information necessary to perform and complete checks on the potential event data in order to validate the event signal integrity and characteristics. If the checks are performed successfully, the event beginning, end and center are calculated in terms of index and distance. The event metrics are saved (beginning, end, center, probability etc.) and the event is registered in the Test Event Table at step 286. A probability margin is also calculated. This metric contains a value indicating how significant the event probability is relative to a “highly significant” or “highly probable” event as identified by the steps of the described process.

The portion of the process at steps 252, 300 uses a splitter prescan approach to more reliably detect splitter configurations. This allows the process for splitter events to be optimized independently of the standard loss event. If the splitter events are not identified accurately with the standard loss/reflection event analysis, a secondary process which focuses on the differential signal (din4) is utilized to confirm the splitter locations.

The overall analysis process depends significantly on the accuracy of the splitter detection. The splitter forms the reference demarcation for the PON network and as such, its characterization is important. If the analysis process cannot reliably find the splitter, control reverts to an error handling system 298 which seeks to automatically rectify the situation through enhanced event detection and confirming scans if necessary.

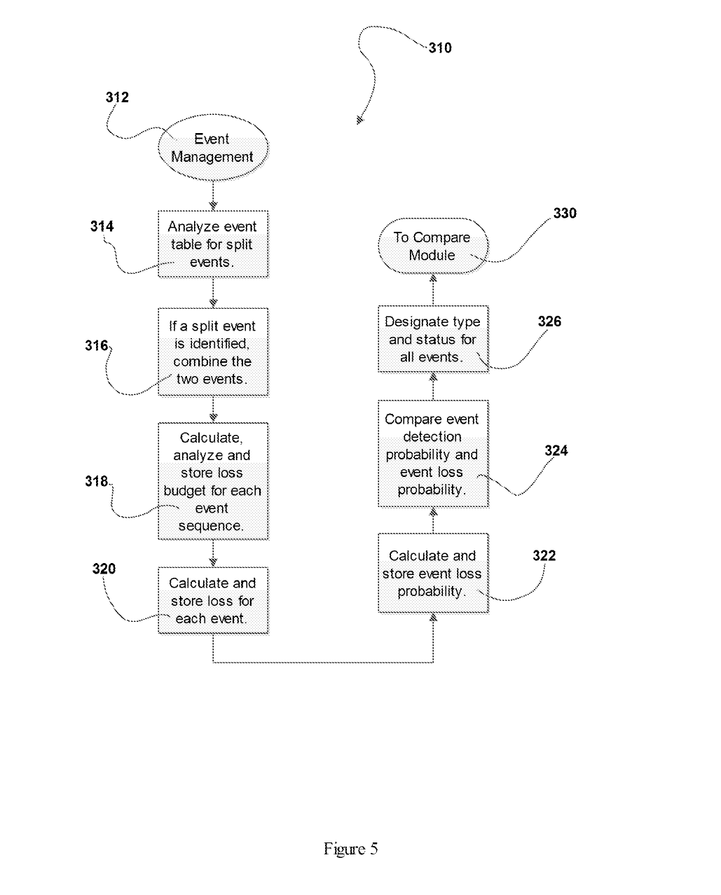

The event management steps 310 are shown in FIG. 5. As a first step, 314, the process searches the Test Event Table (which is populated by validated detected events) and identifies adjacent “events” that should likely be combined into one event. If such events are identified, they are combined to form a new event and the old constituent events are marked as obsolete, as outlined in step 316.

The following step 318, starts with calculating an improved estimate of event ending index and distance for each event. A correction is applied to the event ending location and distance based on the known pulsewidth. Next, the value of the final averaged data (din2) at index 20 samples before boe (beginning of event) is retrieved and designated as the boe budget value. Then, the value of the final averaged data (din2) at index 20 samples after eoe (end of event) is retrieved and designated as the eoe budget value.

Next, at step 320, an event loss factor for normal fiber loss is calculated. The total event loss is calculated from the budget numbers and the fiber loss factor. The event loss and the budget values are then stored.

To begin step 322, a baseline loss value is calculated from a programmable minimum loss number and a loss variability factor. A loss probability metric is then calculated which indicates the calculated event loss relative to the baseline loss value. The loss probability metric is stored.

The calculated event loss metric mentioned above is then compared to a programmable threshold. If sufficiently high, a flag is set (okL). The event detection probability (described above with reference to FIG. 4) is retrieved, scaled and compared to a programmable threshold. If sufficiently high, a flag is set (okP). All combinations (0,0; 0,1; 1,0; 1,1) of the probability flags (okL,okP) are examined and appropriate conditions are specified for each combination. These conditions are as follows:
1. If (okL,okP)=(1,1) and if the loss probability is greater than the event detection probability, then the flag (useLoss) is set to 1. The flag (ok) is also set to 1.
2. If (okL,okP)=(0,0) and if the event detection probability is greater than the loss probability, then the flag (useLoss) is set to 1.
3. If (okL,okP)=(0,1) then the flag (useLoss) is set to 1.
4. If (okL,okP)=(1,0) then the flag (useLoss) is set to 0.

Generally, the type and status for each event is designated in step 326. More specifically, if flag (ok) is set to 1 (both loss probability and event detection probability are sufficiently high) then validate the event status and type (types=tProb, tMinL, tEvent). If flag (ok) is not set to 1, set the event status appropriately. If flag (useLoss) is set to 1, then set the event status appropriately. Set the event probability metric equal to the value of the loss probability. Validate the event status and type. Lastly, validate the total number of events examined and qualified.

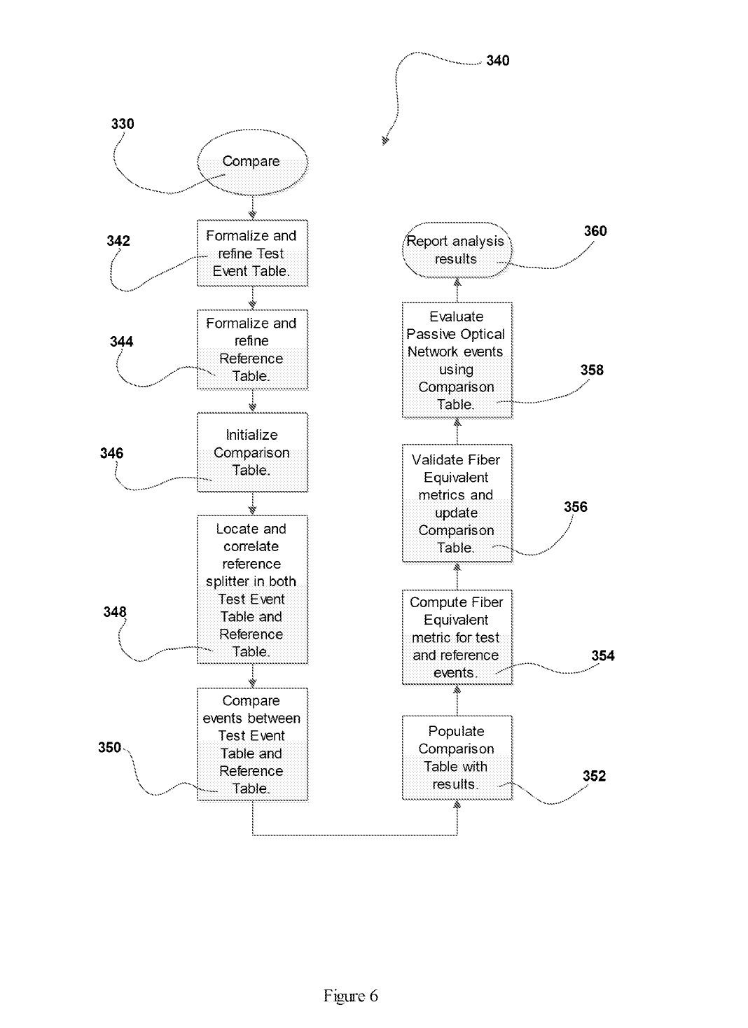

Finally, the process will carry out a comparison procedure 340, as set forth in FIG. 6 and the remaining steps or blocks shown therein. As shown in the figure, additional block information is given in the indicated paragraphs in this disclosure.

Intially, step 342 is carried out to finalize the Test Event Table, to include at least the following fields and metrics for each event:
a. type: classification of event
b. status: validation of event
c. boe: beginning of event location
d. td: total distance to beginning of event, m
e. eoe: end of event location
f. rd: relative distance
g. lo: event loss, dB, otdr
h. lb: event loss by budget
i. lp: event loss, PON, dB
j. bb: budget at boe
k. be: budget at eoe
l. r: event reflection, dB
m. fn: fiber number
n. fe: fiber equivalent
o. ed: event designation
p. j: event row
q. nf: number of fibers
r. rw: event reflection width
s. pd: reflection peak distance
t. pdi: reflection peak distance, interpolated
u. pdc: reflection peak distance, curve
v. em: event message
w. fault: initial fault
x. marg: fe margin
y. prob: event probability
z. ne: number of eofs (end-of-fibers)
aa. feft: fe fault type
bb. loe: loss error
cc. bbe: budget error, bb
dd. bee: budget error, be
ee. i1: event start index
ff. m: event matching flag

Next, at step 344, the Reference Table is finalized to include at least the following fields and metrics for each event:
a. Status: event validation
b. Type: event classification
c. Desgn: designation
d. Fiber: fiber number
e. Fault: fault designation
f. TotDist: total event distance
g. Oloss: otdr loss
h. Ploss: PON loss
i. BudgetB: otdr budget boe
j. BudgetE: otdr budget eoe
k. nEOF: number of fiber ends
l. Refl: amplitude in dB
m. Index: sample index
n. WidRefl: reflection width
o. PkDist: peak reflection distance
p. PkIDist: peak reflection distance interpolated
q. PkCDist: peak reflection distance curve
r. Event_Msg: event information
s. m: event matching flag

Once these tables have been finalized, the process moves to step 346 to construct the Comparison Table and initialize to include at least the following fields and metrics for each event:
a. j: event row
b. es: event status
c. et: event type
d. fault: initial fault type
e. lp: event loss, dB
f. pts: rating points
g. em: event message
h. fn: fiber number
i. ne: number of fiber ends
j. loe: loss error
k. nf: number of fibers
l. eoe: end of event distance
m. tde: total distance error
n. bbe: budget error at event beginning
o. bee: budget error at event ending
p. ed: event designation
q. jr: reference event flag (table row flag)
r. tdr: total event distance reference
s. etr: event type reference
t. feft: fe fault type
u. fType: fe fault type2
v. fe: fiber equivalent
w. bb: budget boe
x. jt: test event flag (table row flag)
y. tdt: total distance from test table
z. ett: test event type
aa. marg: probability margin
bb. td: total distance to event
cc. fer: fiber equivalent reference
dd. fet: fiber equivalent test
ee. femarg: fiber equivalent margin

Next, in step 348, the Reference Table is opened so as to locate the reference splitter based on event type, loss and location. The Test Event Table is also opened and the reference splitter is identified according to event loss and location +/− a programmable tolerance. The location difference between the reference splitters as recorded in the Reference Table and as recorded in the Test Event Table is validated and recorded.

Using both the Reference Table and the Test Event Table, and after correlating the reference splitter event in both tables, each subsequent event is compared in step 350. Each row in the tables refers to a different event arranged in order of distance from the OTDR. Each row is addressed by a single index number. First, the comparison process initializes the table row index and finds the first event in the Test Event Table with a “good” status as qualified and validated with the event detection and event loss procedures described previously. The test event distance dt is validated. The same starting index is used in the Reference Table and the corresponding reference event distance dr is validated. The reference event dr is compared to the test event boe and eoe. The output of this comparison is either a “match,” a “miss,” or a “new” event. A “miss” means there is a reference event but no test event. A “new” means there is a test event but no reference event.

If a “match” is found, the parameter m is set equal to the matching indexes in both tables. The flags xTest and xRef are set indicating that entries from both tables are present. The matching test event type and status is then examined. The matching reference event status is examined. Depending on the results of the event type and status examination, the comparison status is assigned a value. This comparison status is then analyzed and validated. The event distances dr and dt are then compared. This comparison validates that the difference between the event distances dr and dt are within acceptable tolerances. Next, since xTest is set, the Test Event Table parameters are copied into the Comparison Table. These parameters are: es, et, boe, td, eoe, rd, lo, lb, lp, bb, be, r, fn, fe, ed, j, nf, rw, pd, pdi, pdc, em, fault, marg, prob, ne, feft, fType, jt, jr, tdr, tdt, tde, etr, ett, loe, bbe, bee, pts, i1 and i2. The comparison status is then saved in the Comparison Table and eoe is set to 0.0. Since both xRef and xTest are set, the Comparison Table is populated with new computed error parameters tde, bbe, bee and loe which are calculated from the difference between the Test Event Table and Reference Table values. The Comparison Table is then updated with the parameters ed, jr, tdr, et, etr, fn, feft and fType from the Reference Table values. Next, the Comparison Table parameters ne and nf are assigned. Since xTest is set, the Comparison Table parameters jt, tdt, ett, et, eoe are updated from the Test Event Table. Now the Test Event Table parameter, prob is compared with a normalized, scaled version of the Test Event Table parameter, lo. The outcome of this comparison is used to calculate the Comparison Table parameter, marg.

If a “new” event (test event but no corresponding reference) is found, the comparison event distance is assigned the Test Event Table value. The flag xRef is not set while the flag xTest is set. The event status is examined from the Test Event Table. If the Test Event Table status is “new” or “near,” this is copied to the comparison status, otherwise the comparison status is set as “bad.” The comparison status is further evaluated and since xTest is set, the Test Event Table parameters are copied into the Comparison Table. Next, the following values in the Comparison Table are updated from the Test Event Table: et, bb, lo, tdt, ett and eoe. Now the Test Event Table parameter, prob is compared with a normalized, scaled version of the Test Event Table parameter, lo. The outcome of this comparison is used to calculate the Comparison Table parameter, marg.

If a “miss” event (reference event but no corresponding test event) is found, the comparison event distance is assigned the Reference Table value. The parameter m is set equal to a negative one in both tables. The flag xTest is not set while the flag xRef is set. The event status is examined from the Reference Table. If the Reference Table status is “ok,” “ref,” or “fit,” “miss,” “ref,” or “fit” is copied to the comparison status respectively, otherwise the comparison status is set as “bad.” The comparison status is further evaluated and since xRef is set, the Reference Table parameters are copied into the Comparison Table. Next, the following values in the Comparison Table are updated from the Reference Table: ed, tdr, et, etr, fn, feft, fType and eoe. Next, the Comparison Table parameters ne and nf are assigned. The Comparison Table parameter, marg is then updated.

The end result of all the operations mentioned above is a Comparison Table entry corresponding to the “matched,” “new” or “missed” event that details all the characteristics of the event, the comparison results and includes a final updated, validated event status. All of this data is recorded, formalized and validated on a single row in the Comparison Table in step 352. This process repeats for all events recorded in the Test Event Table and Reference Table.

The process will then move to step 354, which computes the fiber-equivalent number for each of the events listed in the Reference Table. This is initiated by opening the Reference Table and assigning special “fe” numbers for the reference splitter event and for the last event in the table. For all other events, the “fe” number is calculated as follows:
a. The event loss is retrieved (L_{otdr}) and if it is less than a programmable threshold, then the fe number is assigned to be a scaled version of the parameter nf.
b. If L_{otdr} exceeds the programmable threshold, the fe number is based on the computed loss of a single lossy fiber in a collection of N−1 lossless fibers at a specific location: [symbol]
c. A fiber-equivalent (fe) number is also computed and assigned for all necessary Test Event Table entries.

The next steps (i.e. step 356) begin by assigning the appropriate Comparison Table parameter, (fer), the value of “fe” from the Reference Table. The Comparison Table parameter, fet, is assigned the value of fe from the Test Event Table. This is done for all events in the tables. Next, the reference splitter event as listed in the Comparison Table is updated with a new fe value. This comparison fe value is computed based on the difference between the splitter Reference Table loss and the splitter Test Event Table loss. For Comparison Table events where there is not a corresponding or matching Test Event Table entry, the parameter, fe, is assigned a special value indicating this condition. For Comparison Table events where both parameters, fet, and fer exist, the difference between them is computed and saved as the Comparison Table parameter, fe for the corresponding event. Next, the event Comparison Table parameter femarg is computed. This margin is essentially the difference between the parameter, fe and programmable thresholds depending on the event type, status and fe polarity.

As a final step in the exemplary process, at step 358 the Comparison Table is opened and searched for the reference splitter event. The existence of valid PON (passive optical network) events is verified and the extent or end of the optical network is determined. Next, the F1 section (upstream of the reference splitter) is checked for faults. After these checks and verifications, event analysis following the reference splitter begins. A search is implemented in the Comparison Table starting with the first valid event following the reference splitter and continued towards the end of the passive network events. The target of the search is to find the first negative excursion of the parameter fe. This negative excursion is a violation of a programmable threshold. If a negative fault is detected, the fault row is saved in the ecFn parameter and a flag is set (flagFn). Next, events following the splitter are searched for the first positive excursion of the parameter fe. If a positive fault is detected, the fault row is saved in the ecFp parameter and a flag is set (flagFp). A general fault is quantified by mathematically calculating a fault value based on an equation using flagFn and flagFp. The general fault value is then analyzed and validated. The result of the analysisis and validation is the location of the nearest fault to the reference splitter. Next, a search is conducted (starting at the end of the Comparison Table looking toward the reference splitter) for the first positive excursion in parameter fe. If a positive fault is found, the row is saved in the ecBp parameter and a flag (flagBp) is set. Its value corresponds to the fault event status. This is followed by a search in the same direction for the first negative excursion in parameter fe. The results of all the searches are then analyzed and the final result detailing the PON fault status is determined based on the values of flagFn and flagBp. The summary output of the overall analysis process contains the location and splitter branch of any fault found. This information can then be output or repeated as necessary or desired.

An example of a PON analysis system 400, is shown in FIG. 7 and will be described next. A typical deployment would include a network server 420, which controls a plurality of remote test units 422. In the usual configuration, this server arrangement allows for a distributed computing environment where the test units are deployed as needed to provide monitoring of an entire network and all main system functions are coordinated and controlled by the centralized computer. The connections between the central server and the remote units can be wired or wireless connections and the services provided include automatic surveillance of all network branches, on-demand testing of specific networks, full network test logging functions, remote unit testing and configuration, comprehensive reporting regarding network status and error conditions, troubleshooting guides and diagnostics. The server configuration can also be confined to a remote test unit if required. The analysis software used to carry out the various processes described above can be loaded on the server computer, on the remote units, or on both as needed to optimize performance.

Continuing with the example analysis system 400 as shown in FIG. 7, the remote test unit (RTU) 422 generally consists of a user interface, a controller (CPU, MCU), memory, expansion bus, peripheral interfaces such as USB, communication interfaces such as ethernet, an optical-time-domain-reflectometer (OTDR) and an optical 1×N switch. The OTDR and the switch may also be distributed separately with the controller function handled by the central computer. In this distributed case, the interfaces and necessary memory are included separately in the OTDR and optical switch.

In FIG. 7, one example of a typical composite optical signal 424, which can be expected in a PON network is generally illustrated. The measurement or monitoring approach outlined herein can be implemented without disruption or negative influence on the normal signal traffic.

System 400 illustrated in FIG. 7 further includes an Optical Line Terminal (OLT) 426. This is typically located in a central office, and has electronic inputs of voice, IP video and data for a single channel within the PON. Optical line terminal (OLT) 426 is also an electronic Data output. The electronic signals are converted to pulsed optical outputs on optical fibers which are then connected to an optical multiplexer. There are multiple channels in the OLT, each composed of multiple optical signals leading to a multiplexer.

Coupled with optical line terminal 426 are a plurality of channel multiplexers 428. Each of these are typically wavelength division multiplexers (WDM) which are passive devices that combine the central office signals (voice and IP video/data onto an outgoing fiber). The devices also multiplex optically converted RF video and the OTDR test signal onto the same outgoing fiber. There are a plurality of multiplexers 428, with each related to one of the multiple channels being monitored by system 400.

Also coupled to the plurality of multiplexers 428 are a plurality of signal sources 430, which each carries an RF video information signal. This RF video signal is converted to a digital optical signal which is then multiplexed onto a channel fiber.

Block 432 represents the end of the single channel fiber which is terminated in a splitter configuration. This splitter 432 is another passive device which splits the incoming multiplexed signal into multiple output multiplexed signals. Splitter 432 allows the signal information to be transmitted to individual subscriber fibers. A plurality of splitters 432 are typically housed in cabinet, along with associated connectors, which together are designated as a Fiber Distribution Hub (FDH). Optically, splitter 432 is a distance marker that delineates the F1 fiber termination.

In the example system 400, each fiber will have a Fiber Distribution Terminal (FDT) 434. This is a typical termination point for PON networks before the final drop fiber is installed to an individual subscriber. Typically, this is physically contained within a small housing that contains multiple positions for connecting a distribution fiber to a drop. Usually, FDT models have either 4, 8 or 12 positions.

Further illustrated in FIG. 7 is a passive reflector component 436 that may or may not be installed at the subscriber's optical network termination. This reflector component 436 is designed to pass all subscriber signals and to reflect the test signal wavelength. The installation of a reflector component 436 is sometimes necessary in order to optically detect the fiber connection to the subscriber's Optical Network Terminal (ONT) with an OTDR pulse due to an insufficient signal-to-noise ratio (SNR) at the ONT.

A final termination point or Optical Network Terminal 438 exists in a PON network, at each of the subscriber's location. The Optical Network Terminal (ONT) 438 provides the necessary optical/electrical conversion interface for all signals. Physically, the ONT 438 is located at the subscriber's home or business, and provides the interface for internet, telephone and video services.

To provide further context and to assist in the understanding of example system 400, listed at a top portion of FIG. 7 are a number of labels which set forth the typical locations, designations or characteristics for several of the components mentioned above. Label 440 indicates the system functions that are typically physically located in a central office environment. This grouping would include the server computer.

Label 442 represents the single main fiber connection or feeder link to the Fiber Distribution Hub from the Central Office. This is typically labeled as the F1 link.

Label 444 represents the single fiber distribution link connecting an output port of one of the Fiber Distribution Hub splitters to one position of a particular Fiber Distribution Terminal. This fiber is typically labeled as the F2 link.

Label 446 in FIG. 7 represents a single drop fiber which connects a distribution link to a customer's Optical Network Terminal. This fiber is typically labeled as the F3 link.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A method of characterizing a passive optical network, comprising:
obtaining optical-time-domain-reflectometry (OTDR) data from the passive optical network;
creating a data array from the optical-time-domain-reflectometry (OTDR) data;
conducting an event analysis to determine the existence of loss events within the passive optical network, and to identify the loss events;
conducting a loss analysis related to the identified loss events, and to characterize a plurality of parameters related to each of the identified loss events, wherein the loss parameters comprise a loss type and a loss status and a loss value for each of the identified loss events; and
preparing a reporting indicating the loss parameters of the passive optical network.

2. The method of claim 1 wherein the passive optical network is newly constructed and the loss parameters are used to validate the newly constructed optical network.

3. The method of claim 1 wherein the passive optical network is already established and the loss parameters are used to monitor the network.

4. The method of claim 1 wherein the loss analysis further comprises determining a fiber equivalent metric corresponding to the loss value at the location of the loss event, wherein the fiber equivalent metric is proportional to a number of fibers at the location if the event loss value is below a predetermined threshold, and wherein the fiber-equivalent metric comprises a fiber equivalent calculation for each loss event, based upon a modeled loss of a single fiber in a collection of a plurality of lossless fiber at the location of the loss event, if the loss value is above the predetermined threshold.

5. The method of claim 1 further comprising:
conducting a reflection analysis of the data array to identify a plurality of reflection events, and summarize a plurality of parameters related to each of the plurality of reflection events;
conducting a reflection event analysis to further validate and analyze each of the reflection events based on a system impulse response template and an event probability calculation;
determining a reflection type and a reflection status for each of the reflection events; and
reporting the reflection type and reflection analysis for each of the plurality of identified reflection events.

6. The method of claim 1 wherein the reported loss parameters comprises information regarding event loss results, an identification of individual fiber channel defects, and indication of a probable location for each of the individual fiber channel defects.

7. The method of claim 1 wherein the event analysis accounts for a wide spectrum of noise effects in the passive optical network.

8. The method of claim 1 wherein the reflectometry data is uniquely filtered to mitigate harmful noise effects, accentuate important signal information and validate event integrity.

9. The method of claim 1 wherein the event analysis provides the identification of a plurality of predetermined splitter events.

10. A method of characterizing a passive optical network, comprising;
obtaining optical-time-domain-reflectometry (OTDR) data from the passive optical network;
creating a data array from the optical-time-domain-reflectometry (OTDR) data;
conducting an event analysis to determine the existence of reflection events within the passive optical network, and to identify the reflection events;
conducting a reflection event analysis to further validate and analyze each of the idetified reflection events based on a system impulse response template and an event probability calculation;
determining a reflection type and a reflection status for each of the reflection events; and
reporting the reflection type and reflection analysis for each of the plurality of identified reflection events.

11. The method of claim 10 wherein the event analysis accounts for a wide spectrum of noise effects in the passive optical network.

12. The method of claim 10 wherein the passive optical network is a newly constructed and the reflection parameters are used to validate the newly constructed optical network.

13. The method of claim 10 wherein the passive optical network is already established and the reflection parameters are used to monitor the network.

14. The method of claim 10 wherein the reflectometry data is uniquely filtered to mitigate harmful noise effects, accentuate important signal information and validate events.

15. The method of claim 10 wherein the event analysis further determines the existence of loss events within the passive optical network and to identifies the loss events, the method further comprising:
conducting a loss analysis related to the identified loss events, and to characterize a plurality of parameters related to each of the identified loss events, wherein the loss parameters comprise a loss type and a loss status and a loss value for each of the identified loss events; and
preparing a reporting indicating the loss parameters of the passive optical network.

16. The method of claim 15 wherein the loss analysis further comprises determining a fiber equivalent metric corresponding to the loss value at the location, where the fiber equivalent metric is proportional to the number of fibers at the location if the event loss value at the location is below a predetermined threshold and wherein the fiber equivalent metric is determined by a fiber equivalent calculation if the loss value is above a threshold, the fiber equivalent calculation based upon a modeled loss of a single fiber in a collection of a plurality of lossless fiber at the location of the loss event.

17. A method for performing reflection and loss analysis of optical-time-domain-reflectometry (OTDR) data acquired for the purpose of characterizing the status of passive optical networks using a previously acquired reflectometry data file retrieved from a passive optical network, the method comprising:
creating a data array from the previously acquired reflectometry data file;
conducting reflection analysis of the data array to identify a plurality of reflection events, and summarize a plurality of parameters related to each of the plurality of reflection events;
conducting an event analysis to further validate and analyze each of the reflection events based on a system impulse response template and an event probability calculation;
determining a reflection type and a reflection status for each of the reflection events;
conducting loss analysis of the data array to identify a plurality of loss events, and to summarize a plurality of parameters related to each of the plurality of loss events;
conducting an event analysis to further validate and analyze each of the loss events based on standard loss measurements, probability calculations and a fiber-equivalent metric, resulting in a loss characterization for each of the loss events;
determining a loss type and a loss status for each of the loss events; and
generating a report characterizing the passive optical network.

18. The method of claim 17 wherein the event analysis provides the identification of a plurality of predetermined splitter events.

19. The method of claim 17 wherein the event analysis accounts for a wide spectrum of noise effects in the passive optical network.

20. The method of claim 17 wherein the passive optical network is newly constructed and the loss and reflection parameters are used to validate the newly constructed optical network.

21. The method of claim 17 wherein the passive optical network is already established and the loss and reflection parameters are used to monitor the network.

22. The method of claim 17 wherein the reflectometry data is uniquely filtered to mitigate harmful noise effects, accentuate important signal information and validate detected events.

23. The method of claim 17 wherein the analysis, validation or monitoring is completed using existing PON network components.

24. The method of claim 17 wherein the report characterizing the optical network comprises information regarding event characterization results, an identification of individual fiber channel defects, and indication of a probable location for each of the individual fiber channel defects.

25. The method of claim 17 wherein the fiber equivalent metric is a constant if the event loss value at the location is below a predetermined threshold, wherein the fiber-equivalent metric comprises a fiber equivalent calculation for each loss event, based upon a computed loss of a single fiber in a collection of a plurality of lossless fiber at the location of the loss event.
